(19) United States
(12) Patent Application Publication
(10) Pub. No.: US 2013/0233143 A1
(43) Pub. Date: Sep. 12, 2013

(54) Base for Manual Candy Block Cutter

(71) Applicant: CHIA-MEI CHEN, New Taipei City (TW)

(72) Inventor: CHIA-MEI CHEN, New Taipei City (TW)

(21) Appl. No.: 13/786,465

(22) Filed: Mar. 6, 2013

(30) Foreign Application Priority Data
Mar. 9, 2012 (TW) 101204298

(51) Int. Cl. B26D 7/28

(52) U.S. Cl. CPC B26D 7/28
USPC 83/522.24

(57) ABSTRACT

A base for manual candy block cutter includes a cutting platform. The cutting platform has a side to which a measuring rack with a scale marking section is mounted. The measuring rack has a side that is away from the cutting platform and is provided, in a slidable manner, with cutting stop board. The cutting platform is provided with a cutter seat at the side adjacent to the measuring rack. The cutter seat has a side that is away from the cutting platform and is provided with a cutter pivoted to an end thereof. A cutter retainer is provided to extend both the cutter and the cutter seat. In a cutting operation, the cutting stop board is moved to align a marking of the scale marking section and an object to be cut is positioned against the cutting stop board in order to control the size of a cut piece.

### (a) TECHNICAL FIELD OF THE INVENTION

The present invention generally relates to a manual cutting device, and more particularly to a base for manual candy block cutter that can carry out precise cutting of various sizes and shows high operation safety.

### (b) DESCRIPTION OF THE PRIOR ART

Traditionally, a kitchen knife is used in combination with a chopping board to cut food. However, in cutting foodstuffs that have a rounded and slippery surface or have high rigidity, it is generally difficult to control cut thickness. Further, due to the foodstuffs being hard to be securely positioned on the chopping board or even sliding away or flying away from the chopping board, or simply because the kitchen knife is held by a human hand and is moved downward from a high location, the operation of cutting cannot be precisely controlled. A person hurting his or her arms in cutting foodstuff often occurs. Further, besides being impossible to cut to a desired thickness, it often needs to take several repeating chopping movement to completely cut off the foodstuffs. This leads to broken and damaged appearance of food, making it difficult to sell. Thus, cutting devices for use with kitchen knife are available.

The kitchen knife based cutting device comprises a chopping board, a knife seat, and a knife. The chopping board comprises an elongate trough formed therein. The knife seat is arranged beside the elongate trough of the chopping board. The knife has a handle and a front end that is distant from the handle. The front end of the knife is pivoted to the knife seat so that the knife may rotate with the pivot as a rotation center to allow the blade of the knife to make relative movement with respect to the elongate trough. However, the size of the foodstuff block that is cut off with the knife still has to be visually identified. If the cutting goes on for a large amount of food, the operation of cutting is surely exhausting and the cut pieces of foodstuff will be of variable sizes. If the cutting device is used to cut sticky foodstuffs, residues of the foodstuffs may be left and stuck to one side surface of the knife or the elongate trough and will surely interfere with the subsequent cutting operation when the device is used to continuously cut a large amount of food. Cleaning the residues is generally difficult and dangerous. In addition, the knife is not secured and may sway when the cutting device is being moved. This is surely dangerous.

Thus, overcoming such a problem is definitely a goal to be achieved by the manufacturers of the field.

### SUMMARY OF THE INVENTION

In view of the above discussed problems and shortcomings, the present invention aims to overcome these problems and shortcomings by providing a base for manual candy block cutter that can carry out cutting with precise size control and is of high safety.

Thus, the primary object of the present invention is to ensure precise and easy control of cutting any desired size of food and also to achieve high safety.

Another object of the present invention is to prevent an object that is cut and residues thereof from accumulating beside a cutter.

To achieve the above objects, the present invention comprises, structurally, a cutting platform. A cutter seat is arranged at one side of the cutting platform. The cutter seat has one side that is opposite to the cutting platform and is provided with a cutter pivoted to an end thereof. The cutter has an end distant from the pivot of the cutter seat and provided with a handle. At least one cutter retainer is set to penetrate through both the cutter and the cutter seat. Further, the cutting platform is provided with at least one measuring rack at the side thereof adjacent to the cutter seat. The measuring rack comprises at least one scale marking section formed thereon. The measuring rack is provided, in a slidable manner, with a cutting stop board at the side away from the cutting platform. At least one fastener is provided, penetrating through both the measuring rack and the cutting stop board. In addition, the measuring rack is provided with at least one sliding section that is formed in a portion thereof adjacent to the fastener. To cut an object-to-be-cut, the fastener is released and the cutting stop board is moved to align with a marking of the scale marking section in order to effect adjustment of the desired cutting measure. The fastener then secures the cutting stop board. The object-to-be-cut is positioned against the cutting stop board in order to control the location where cut is made. The cutter is then used to carry out cutting and a cut piece of the object-to-be-cut may separate directly from the cutting platform. After use, the cutter retainer may be used to retain the cutter in the cutter seat. With the above described manner, the problems found in the prior art that the size of cut piece can only be identified visually when cutting is done with a conventional kitchen knife based cutting device and the cut piece may get accumulated beside the knife or the elongate trough and the knife may randomly sway in transporting and stowing the cutting device can be eliminated and improvements of being precisely and easily cut any desired size and high safety can be achieved. Further, additional advantages of preventing a cut piece and residues thereof from accumulating by a cutter are also achieved.

The pressing plate is rotatably mounted inside the casing members above the wire hold-down plate. The pressing plate has a circumference that forms a plurality of pressing edges corresponding to the engagement edge of the wire hold-down plate. The pressing edges are of different distances from the center of the pressing plate. The pressing plate is operable to selectively set the pressing edges in tight engagement with the engagement edge of the wire hold-down plate.

As such, with the previously described technical solution adopted by the present invention, the nailing gun according to the present invention uses the pressing plate that has a plurality of pressing edges to change the height by which the wire hold-down plate extends outward so as to clamp and hold down wires of different gauges and such an operation can be done by simply rotating the pressing plate. Thus, the present invention is simple in structure and secured in assembly without the concern of parts loss and causing no interference with the operation smoothness of nail striking. The manufacture cost is reduced and added value is thus raised thereby enhancing the economic value.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a nailing gun according to the present invention, illustrating the structure of the present invention and spatial relationship among components thereof.

FIG. 2 is a top plan view of the preferred embodiment of the present invention.

FIG. 3 is a perspective view illustrating a measure specifying operation of the preferred embodiment of the present invention.

FIG. 4 is a perspective view illustrating a positioning operation of the preferred embodiment of the present invention.

FIG. 5 is a perspective view illustrating a cutting operation of the preferred embodiment of the present invention.

FIG. 6 is a perspective illustrating a securing operation of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

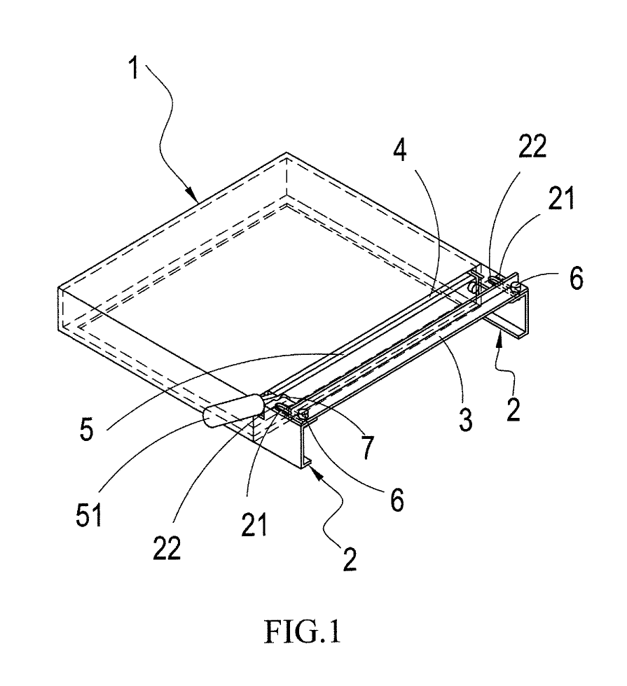

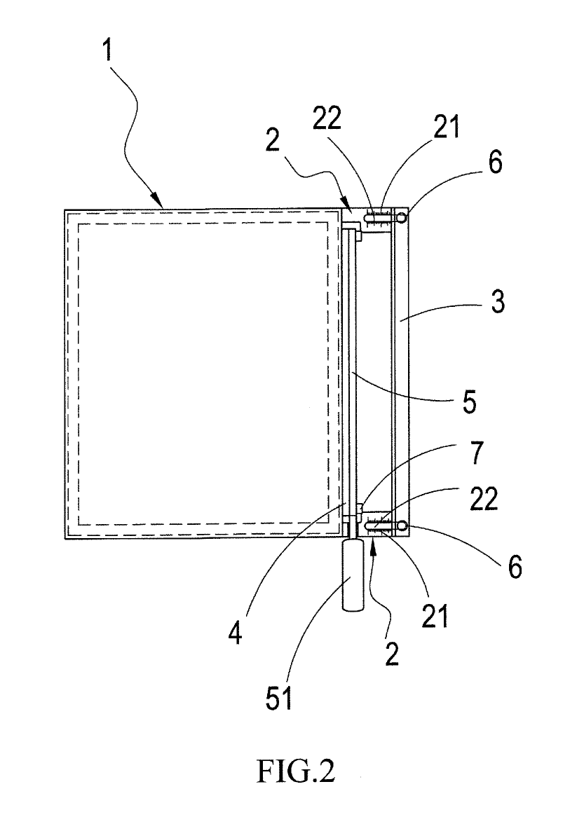

Referring to FIGS. 1 and 2, which are respectively a perspective view and a top plan view of a preferred embodiment of the present invention, these drawings clearly show that the base for manual candy block cutter according to the present invention comprises a cutting platform 1. The cutting platform 1 comprises a hollow casing and the cutting platform 1 is preferably made of stainless steel. The cutting platform 1 shown in the drawings and described above is just one of a number of feasible embodiments thereof and the material and the structure thereof are not limited to any specific types. The cutting platform 1 has one side to which at least one measuring rack 2 is mounted. The measuring rack 2 comprises a scale marking section 21 formed thereon. Further, the measuring rack 2 comprises a cutting stop board 3 that is slidably mounted thereto at the side thereof where the scale marking section 21 is formed and is distant from the cutting platform 1. At least one fastener 6 is mounted by penetrating through both the cutting stop board 3 and the measuring rack 2. The measuring rack 2 comprises at least one sliding section 22 that is formed in a portion thereof adjacent to the fastener 6. The cutting platform 1 is provided with a cutter seat 4 at the sidewall thereof adjacent to the measuring rack 2. The cutter seat 4 is pivoted, at one end thereof, to a cutter 5 located at the side thereof opposite to the cutting platform 1. The cutter 5 is provided with a handle 51 at the end thereof that is opposite to the pivot with the cutter seat 4. The cutter 5 and the cutter seat 4 collectively receive a cutter retainer 7 penetrating therethrough. The cutter seat 4 and the cutter 5 are made of stainless steel material that have surfaces subjected to treatment with Teflon of food roasting grade. The cutter seat 4 and the cutter 5 described above are just one of a variety of feasible embodiments thereof and the material and treatment are not limited to what described above.

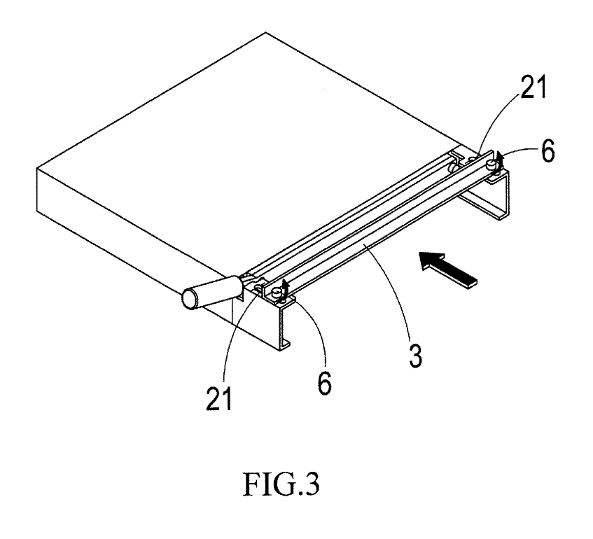

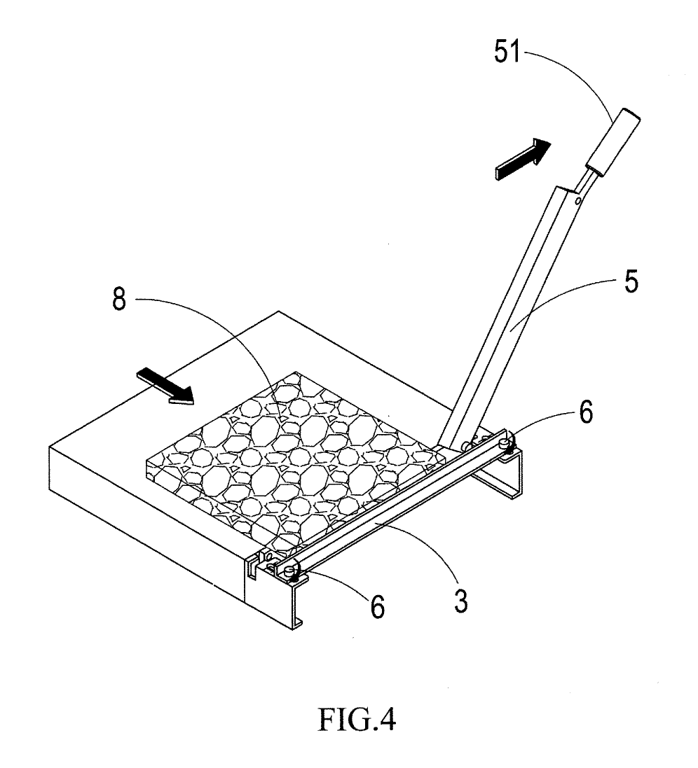

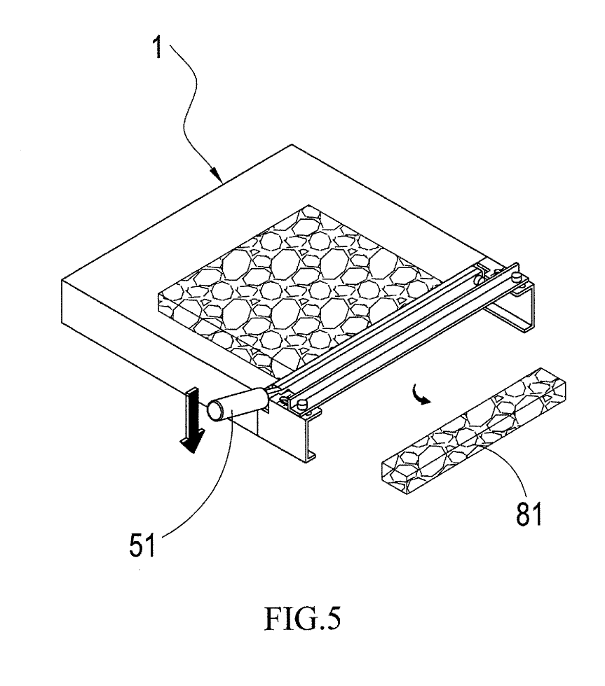

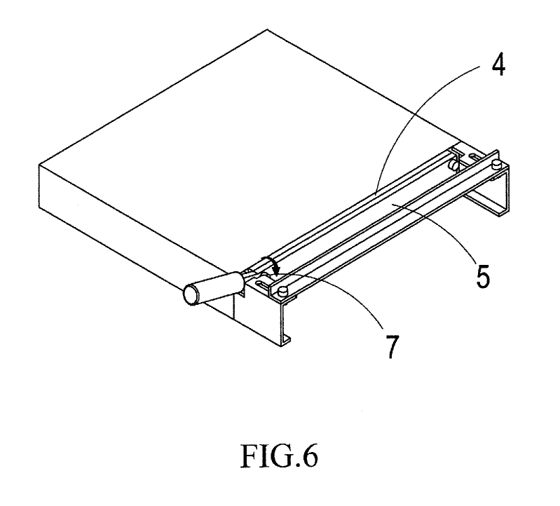

With the arrangement and structure described above, the operation of the present invention will be described as follows, with reference to FIGS. 1-6, which are respectively a perspective view and a top plan view of the preferred embodiment of the present invention, a perspective view illustrating a measure specifying operation, a perspective view illustrating a positioning operation, a perspective view illustrating a cutting operation, and a perspective illustrating a securing operation, these drawings clearly show that to use the cutter according to the present invention, the fastener 6 is released first to allow the cutting stop board 3 to move. The cutting stop board 3 is then moved to align with a target one of the markings of the scale marking section 21 in order to effect adjustment of the desired cutting measure. The fastener 6 is then secured again to prevent the cutting stop board 3 from further movement. The handle 51 is than held by a hand to lift the cutter 5. An object-to-be-cut 8 is then positioned against the cutting stop board 3 to control the location where cut is to be made and the handle 51 is held by a hand to apply a force to proceed with cutting so that the size of a cut piece 81 can be properly controlled. After the cutting, the cut piece 81 separates from the cutting platform 1. After use, a cutter retainer 7 is used to retain and secure the cutter 5 in the cutter seat 4.

Referring to all the drawings, compared to the prior art, the present invention shows the following advantages:

(1) The coordination among the measuring rack 2, the scale marking section 21, the cutting stop board 3, and the fastener 6 allow of precise control of the distance between the cutting stop board 3 and the cutter so that the present invention can provide a practical improvement of easily and precisely cut any desired sizes.

(2) The cutter retainer 7 can retain and secure the cutter 5 in the cutter seat 4 so that when the present invention is transported and stowed, the cutter 5 will not easily rotate thereby achieving a practical improvement of high safety.

(3) The cutter 5 and the cutter seat 4 are arranged at one side of the cutting platform 1 so that the present invention may achieve practical safety of preventing a cut piece and residues thereof from accumulating by the cutter 5.

(4) The cutting platform 1 is a hollow casing so that the present invention can be easily moved in an effortless manner.

(5) The cutting platform 1, the cutter seat 4, and the cutter 5 are made of stainless steel and this ensures hygiene of the present invention without mold growing thereon.

(6) The cutter seat 4 and the cutter 5 are subjected to treatment with Teflon of food roasting grade and this provides convenience of cleansing by using a wet fabric to wipe.

(7) The handle 51 that is provided to operate with the cutter seat 4 and the cutter 5 that are made of stainless steel ensures an effortless operation of cutting. In addition, the cutter 5 is ground at a specific angle for sharpening so that the present invention achieves convenience of operation of easily carrying out continuously cutting operations.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A base for manual candy block cutter, comprising:
a cutting platform;
at least one measuring rack, which is arranged at a side of the cutting platform;
a cutting stop board, which is slidably mounted to a side of the measuring rack that is opposite to the cutting platform;
a cutter seat, which is mounted to a sidewall of the cutting platform that is adjacent to the measuring rack; and
a cutter, which has an end pivoted to an end of the cutter seat at a side thereof distant from the cutting platform.

2. The base for manual candy block cutter according to claim 1, wherein the measuring rack comprises at least one scale marking section formed thereon.

3. The base for manual candy block cutter according to claim 1, wherein the cutting stop board and the measuring rack collectively receive a fastener penetrating therethrough.

4. The base for manual candy block cutter according to claim 3, wherein the measuring rack forms at least one sliding section in a portion thereof adjacent to the fastener.

5. The base for manual candy block cutter according to claim 1, wherein the cutter and the cutter seat collectively receive at least one cutter retainer to extend therethrough.

6. The base for manual candy block cutter according to claim 1, wherein the cutter has an end that is away from the pivot thereof with the cutter seat and is provided with a handle.

7. The base for manual candy block cutter according to claim 1, wherein the cutting platform comprises a hollow casing.

8. The base for manual candy block cutter according to claim 1, wherein the cutting platform is made of stainless steel.

9. The base for manual candy block cutter according to claim 1, wherein the cutter and the cutter seat are made of stainless steel and have surfaces that are subject to treatment with Teflon of food roasting grade.
